(19) United States
(12) Patent Application Publication
(10) Pub. No.: US 2014/0116477 A1
(43) Pub. Date: May 1, 2014

(54) SELECTABLE SPRAY WASHING SYSTEM

(71) Applicant: Dale C. Hartke, Evansville, IN (US)

(72) Inventor: Dale C. Hartke, Evansville, IN (US)

(21) Appl. No.: 14/063,010

(22) Filed: Oct. 25, 2013

Related U.S. Application Data
(60) Provisional application No. 61/718,370, filed on Oct. 25, 2012.

(51) Int. Cl. A01K 13/00; B08B 3/04

(52) U.S. Cl. CPC A01K 13/001; B08B 3/04
USPC 134/103.2

(57) ABSTRACT

A selectable washing system, particularly useful for washing of dogs and other pets, is provided. The selectable washing system specifically relates to an improved, multi-port, multi-valve selectable washing system that allows individual selection of multiple solutions individually to create a custom mix of solutions. The washing system includes a manifold having a plurality of inlet openings and an outlet opening disposed therein. Each of the inlet openings in the manifold is connected to a corresponding solution supply container by one or more valves. According to one presently preferred embodiment, both a needle valve and shut-off valve are positioned between each manifold inlet and its corresponding solution supply container. The output of the manifold is connected to a venturi valve which draws the custom solution mix into a stream of water to be applied to the coat of the pet in diluted form.

### FIELD OF THE INVENTION

The invention relates to spray washing systems, and specifically relates to an improved, multi-port, multi-valve selectable washing system that allows individual selection of multiple solutions individually to create a custom mix of solutions. The spray washing system is particularly useful for washing of dogs and other pets (i.e. groomers, veterinarians, borders), but also has application in the equipment washing industry, car washing, in-home shower systems for human use, and may have additional applications in the agricultural industry.

### BACKGROUND OF THE INVENTION

Giving a dog a bath can sometimes be a difficult task. First, the dog's coat must be wetted, and then shampoo applied and worked into the coat, lathered and rinsed. Additional solutions, such as conditioner, flea and tick repellant, optical brighteners and the like must be applied separately, requiring additional wash cycles.

Systems have been developed to combine shampoo with the water to expedite the process. Systems that are currently available allow a user to select one of a plurality of solutions for mixing with water to be applied directly to the dog's coat. While these systems are more convenient than traditional bathing methods, drawbacks still exist. Most of these prior art systems are configured to work only with a specific solution and cannot be used with solutions of differing viscosity or thickness or to blend multiple combinations of solutions. If a user wants to use a different solution with these devices, they must first dilute the solution or mix it with another solution to achieve the desired viscosity and thickness. None of the known prior art systems allow for adjustability of the flow rate, nor do they allow direct mixing of multiple solutions.

Thus, there is a need for a system that can accommodate solutions of all different viscosities and thicknesses. There is also a need for a system wherein multiple solutions can be mixed directly together thereby avoiding multiple applications of different solutions.

### SUMMARY OF THE INVENTION

The present invention provides a selectable spray wash system where the solution does not control the device. Rather, the device controls and modifies the solution. The invention is a multi-port, multi-valve selectable washing system that allows individual selection of solutions such as shampoo, conditioner, moisturizer, flea treatment, coat brightener and the like. The solutions can be applied one at a time, or a custom mix in virtually unlimited combinations and concentrations can be provided.

The selectable spray wash system of the present invention includes an in-line manifold system that allows for many solutions to be used based on the number of inlet ports utilized. The manifold system allows for mixing and combining of solutions in infinite variations and concentrations. Furthermore, each solution supply includes a dual valve system that further adds flexibility or shutting on and off any incoming solution line without having to readjust flow rates. By using adjustable needle valves, the flow rate may be adjusted for use with virtually any shampoo or solution. The needle valves also allow injection percentage in unlimited combinations.

According to a first aspect of the present invention there is provided a selectable washing system having a manifold, a plurality of solution supply containers, a plurality of inlet valve assemblies, and means for injecting a mixture of solution into a stream of liquid. The manifold includes a plurality of inlet openings for receiving a plurality of corresponding solutions. The manifold also includes an outlet for discharging a mixture of the plurality of solutions. A plurality of solution supply containers are provided corresponding to and connected to the plurality of inlet openings. A plurality of inlet valve assemblies corresponding to and positioned between the plurality of solution supply containers and the plurality of inlet openings are also provided. The means for injecting said mixture of said plurality of solutions into a stream of liquid is connected to the manifold outlet.

A variety of valve types may be used according to the present invention. According to one aspect, each of said plurality of inlet valve assemblies includes an adjustable flow valve. According to another aspect, each of said plurality of inlet valve assemblies further includes a shut-off valve. The adjustable flow valve may be a needle valve, and may further be positioned between said shut-off valve and said manifold inlet opening.

According to a further aspect of the invention, there may be further provided one or more manifold plugs configured to be removably inserted into a corresponding one or more of said plurality of manifold inlet openings.

Yet a further aspect of the present invention is the injecting means, which may include an injection valve. The injection valve includes a liquid inlet port connected to a supply of liquid, a solution inlet port connected to said manifold outlet for receiving said mixture of said plurality of solutions, and an outlet port for discharging a combination of said liquid and said mixture of said plurality of solutions. A shut-off valve located between said manifold outlet and said solution inlet port of said injection valve may also be provided. The injection valve is preferably a venturi valve.

Yet a further aspect of the invention is to provide an inlet fitting connected to said liquid inlet port of said injection valve by a first length of tubing, and an outlet fitting connected to said liquid outlet port of said injection valve by a second length of tubing. A length of flexible hose having a first end connected to said outlet fitting and a second end connected to a nozzle may also be provided.

The present invention is faster and more efficient than traditional animal bathing. It is no longer necessary for the user to pre-wet or work the soap into the animal's coat by hand, saving up to 50% of the time required to wash an animal, while also saving up to 50% of the shampoo or chemicals applied.

These and other objects, features and advantages of the present invention will become apparent with reference to the text and the drawings of this application.

### BRIEF DESCRIPTION OF THE DRAWINGS

FIG. 1 is a schematic drawing of the working components of a selectable spray washing system according to one preferred embodiment of the present invention.

FIG. 2 is a top view in elevation of a manifold assembly of a selectable spray washing system according to an alternative embodiment of the present invention shown configured for three solution inputs.

FIG. 3 is a side view in elevation of a selectable spray washing system according to another embodiment of the invention shown configured with five inputs shown with only an adjustable needle valve and without corresponding shutoff valves.

FIG. 4 is a side view in elevation of a low pressure chemical injection valve used in conjunction with the selectable spray washing system.

FIG. 5 is a perspective view of the selectable spray washing system shown in FIG. 2.

FIG. 6 is a reverse perspective view of the selectable spray washing system shown in FIG. 3.

FIG. 7 is an end view in elevation of the low pressure chemical injection valve shown in FIG. 4.

FIG. 8 is an end view in perspective of the selectable spray washing system shown in FIG. 2, shown with the housing and water outlet.

FIG. 9 is a top plan view of selectable spray washing system shown in FIG. 3.

FIG. 10 is a top view in elevation of the low pressure chemical injection valve shown in FIG. 4.

FIG. 11 is a reverse perspective view of the selectable spray washing system shown in FIG. 2.

FIG. 12 is a top plan view of the selectable spray washing system shown in FIG. 2, shown including the housing, water inlet and water outlet.

FIG. 13 is an end view in elevation of the selectable spray washing system shown in FIG. 12.

FIG. 14 is a bottom plan view of the selectable spray washing system shown in FIG. 2.

FIG. 15 is a perspective view in elevation of the selectable spray washing system shown in FIG. 9.

FIG. 16 is a side view in elevation of the selectable spray washing system shown in FIG. 12.

FIG. 17 is a bottom perspective view of the selectable spray washing system shown in FIG. 2.

FIG. 18 is a top plan view of the selectable spray washing system shown in FIG. 9.

FIG. 19 is a top plan view of the selectable spray washing system shown in FIG. 12.

FIG. 20 is a side view in perspective of the selectable spray washing system shown in FIG. 12.

FIG. 21 is a side view in elevation of an adjustable needle valve used in the selectable spray washing system according to the present invention.

FIG. 22 is a side view in elevation of the selectable spray washing system shown in FIG. 2.

FIG. 23 is a top plan view of the selectable spray washing system shown in FIG. 12.

FIG. 24 is an end view in elevation of the selectable spray washing system shown in FIG. 12.

FIG. 25 is a top plan view of the selectable spray washing system shown in FIG. 2.

FIG. 26 is a perspective view of the selectable spray washing system shown in FIG. 12.

FIG. 27 is an end view in elevation of the selectable spray washing system shown in FIG. 12.

FIG. 28 is a side view in elevation of a shut-off valve used in the selectable spray washing system according to the present invention.

FIG. 29 is a side view in elevation of the manifold used in the selectable spray washing system according to the present invention.

FIG. 30 is a close-up view of the manifold shown in FIG. 29.

FIG. 31 is a top plan view of a selectable spray washing system according to an alternate preferred embodiment of the present invention.

FIG. 32 is a top view in elevation of the selectable spray washing system shown in FIG. 31.

FIG. 33 is a side view in elevation of the water supply line and low pressure chemical injection valve used in the selectable spray washing system of the present invention.

FIG. 34 is a schematic drawing of the working components of a selectable spray washing system according to an alternative preferred embodiment of the present invention.

FIG. 35 is a front view in perspective of the selectable spray washing system shown in FIG. 34.

FIG. 36 is a front view in perspective of a selectable spray washing system similar to the one shown in FIG. 35, but shown here with a single metering valve.

### DETAILED DESCRIPTION OF PREFERRED EMBODIMENTS

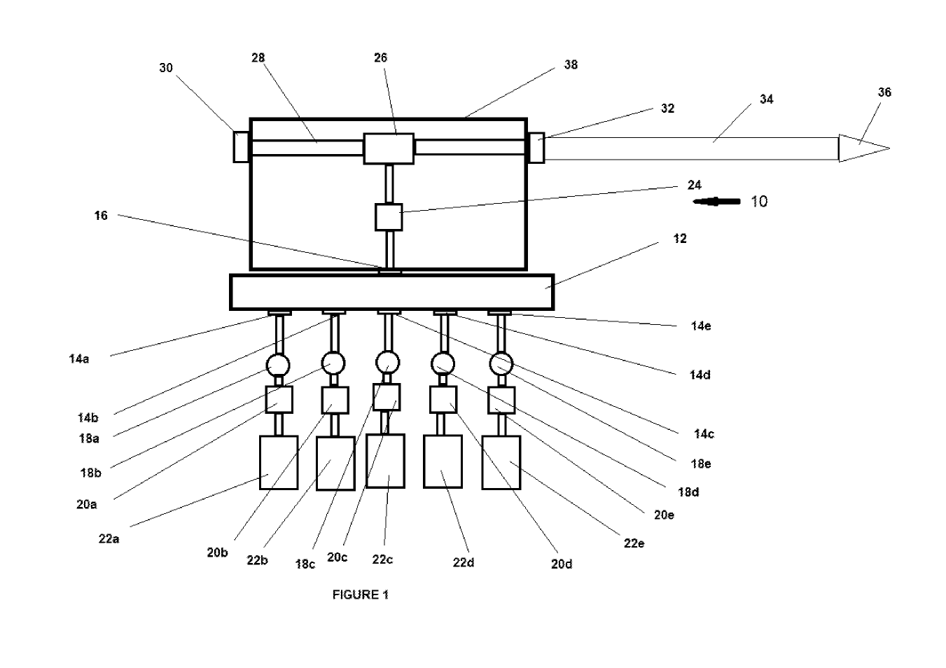

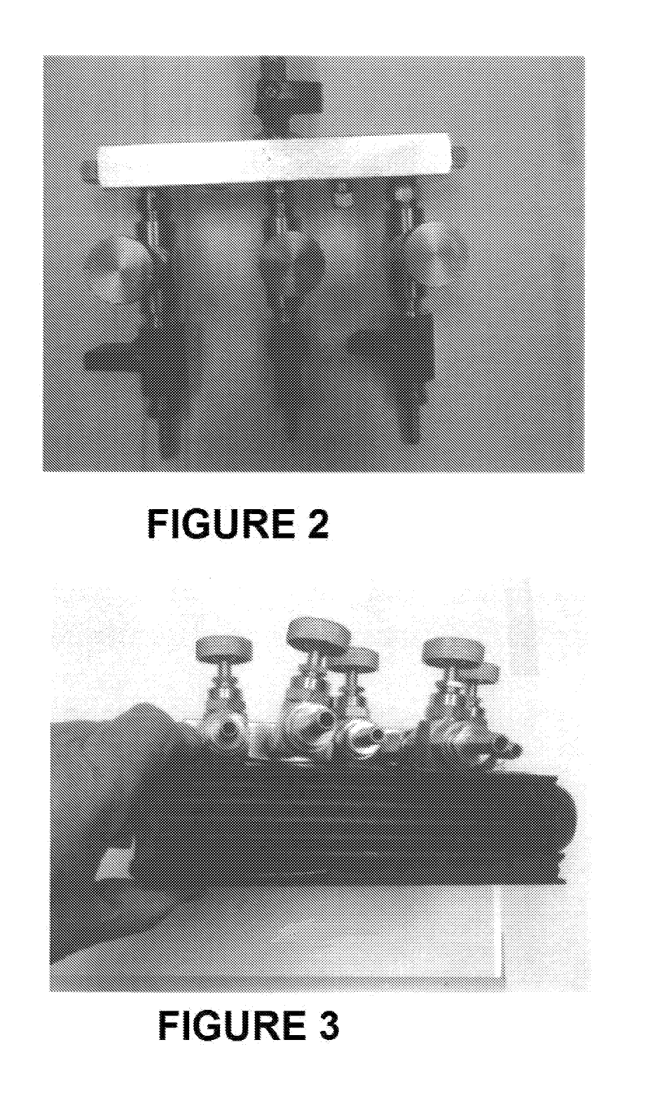

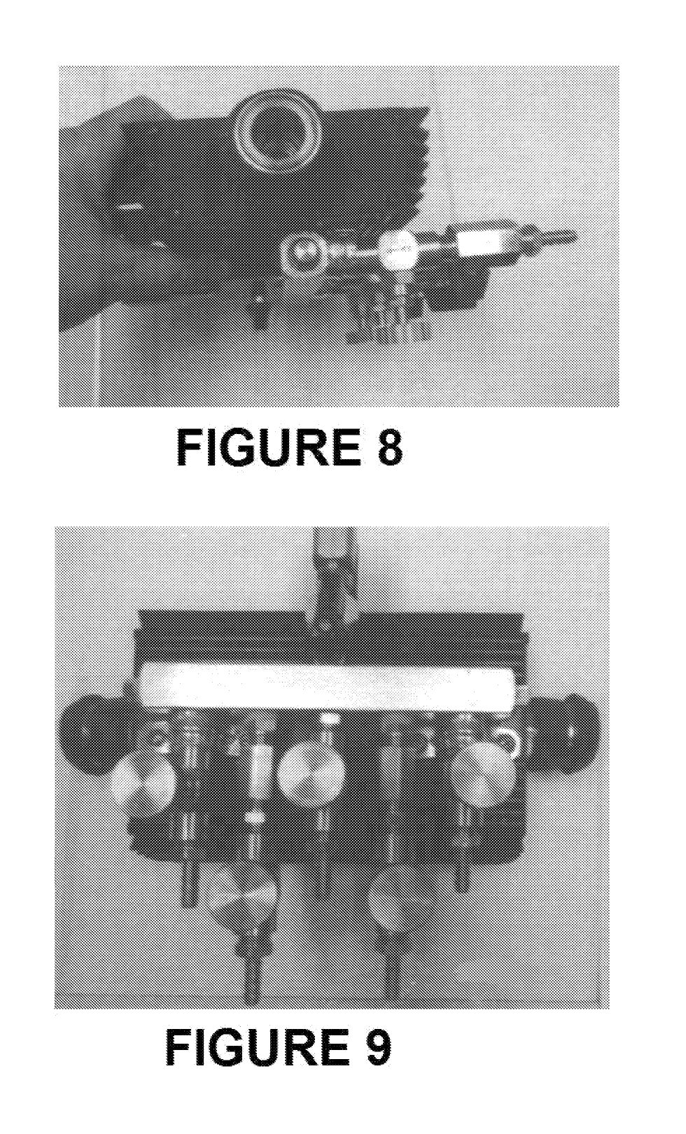

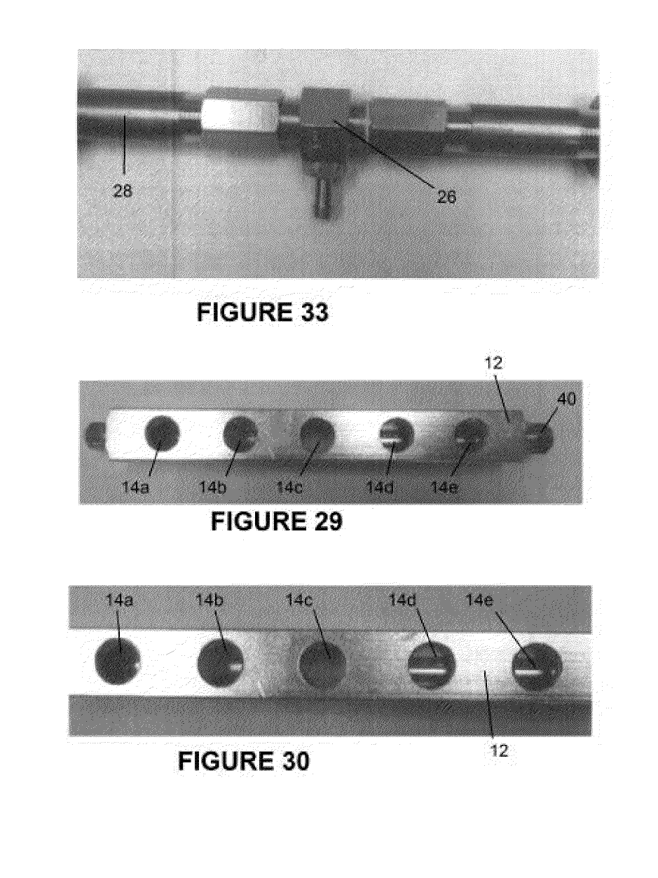

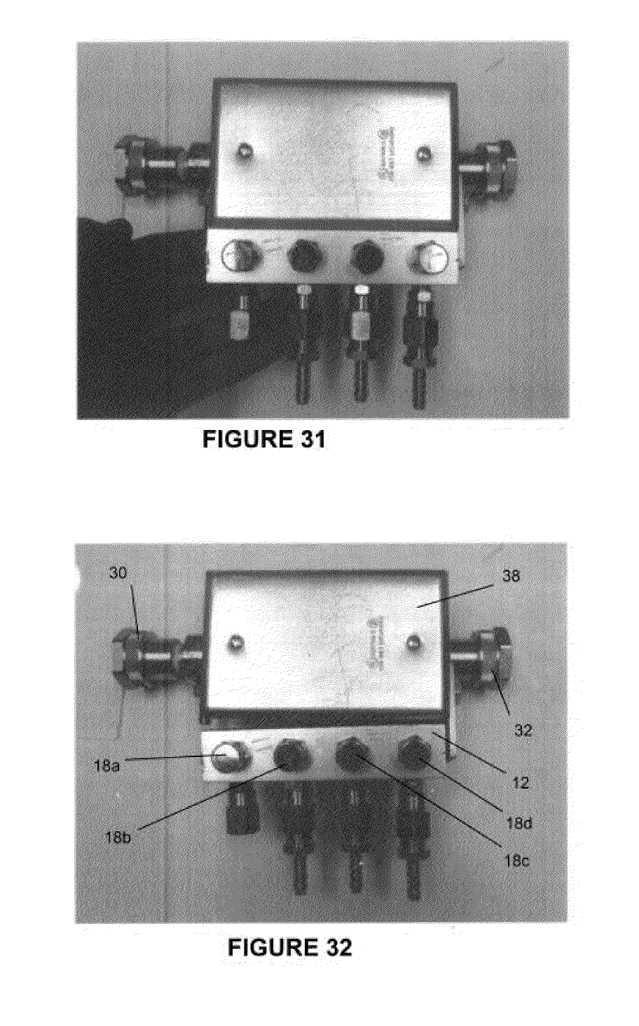

FIG. 1 illustrates a selectable washing system 10 according to one presently preferred embodiment of the invention. The washing system 10 includes a manifold 12 having a plurality of inlet openings 14a, 14b, 14c, 14d, 14e and an outlet opening 16 disposed therein. The manifold 12 may have additional inlet openings, such as the inlet openings on the ends thereof as shown best in FIG. 29. The inlet openings that are not being utilized may be covered by a manifold plug 40 as shown in FIG. 29. While FIG. 1 shows the manifold 12 having five openings, with all five openings connected to solution supply containers 22a, 22b, 22c, 22d, 22e, and FIG. 9 shows the manifold having seven openings with the two end openings being covered by manifold plugs 40, it is understood that any combination of two or more inlet openings may be utilized in practicing the present invention. For example, FIG. 2 shows a configuration in which three inlet openings 14a, 14c, 14e are connected to three corresponding solution supply containers 22a, 22c, 22d, while the remaining inlet openings are covered by manifold plugs 40.

Each of the inlet openings 14a, 14b, 14c, 14d, 14e in the manifold 12 is connected to a corresponding solution supply container 22 by one or more valves 18, 20. According to a presently preferred embodiment, and as shown in FIG. 1, both a needle valve 18 and shut-off valve 20, are positioned between each manifold inlet 14a, 14b, 14c, 14d, 14e and its corresponding solution supply container 22. The needle valve 18 allows each source to be set at its own rate of flow or percentage of injection and concentration. The needle valve 18 also allows an adjustable rate of injection so virtually any shampoo or solution can be used. Each can be custom adjusted for individual thickness, viscosity, and desired flow rate. By adjusting each needle valve 18 the incoming concentration of each corresponding solution can be varied allowing for an unlimited blend of custom mixes from the plurality of sources. By providing a shut-off valve 20 in-line with each needle valve 18 additional flexibility is built into the system. For example, a user can set the desired flow rate for each solution via the needle valves 18, and the shut-off valve 20 allows the user to preserve the desired setting of the needle valve 18, but still shut off flow of the solution when desired via shut-off valve 20. With shut-off valves 20 provided for each solution storage container 22, a user can individually shut off any of the incoming solution lines. By turning the flow on and off without adjusting the needle valve 20, a user can go back to his or her “perfect” wash ratio without the need to readjust the flow rate.

On the outlet side of the manifold 12 there is provided a single outlet 16 which is connected to a low pressure chemical injection valve 26 for injecting solution from one or more of the solution storage containers 22 into the water supply line 28. A shut-off valve 24 is also provided between the manifold outlet 16 and the injection valve 26 to allow immediate cut off of solution into the water supply. By having the shut-off valve 24 on the outlet side of the manifold 12, the user can go straight from wash mode to rinse mode without having to wait for the solution mixture to flush completely from the manifold 12.

Each end of the water supply line 28 has a fitting for permitting water supply to be attached thereto. A water inlet fitting 30 is provided on the inlet side of the water supply line 28 and a water outlet fitting 32 is provided on the outlet side. Threaded connectors or quick-connect connectors can be utilized for each of the inlet and outlet fittings to ensure a water-tight seal. A standard ⅜ inch supply or ½ inch supply line or hose may be attached to the inlet fitting 30 to supply water to the system. A flexible hose 34 having a spray nozzle 36 at the end thereof may be attached to the outlet fitting 32. A housing 38 may also be provided to enclose and protect the components of the system and for aesthetic reasons.

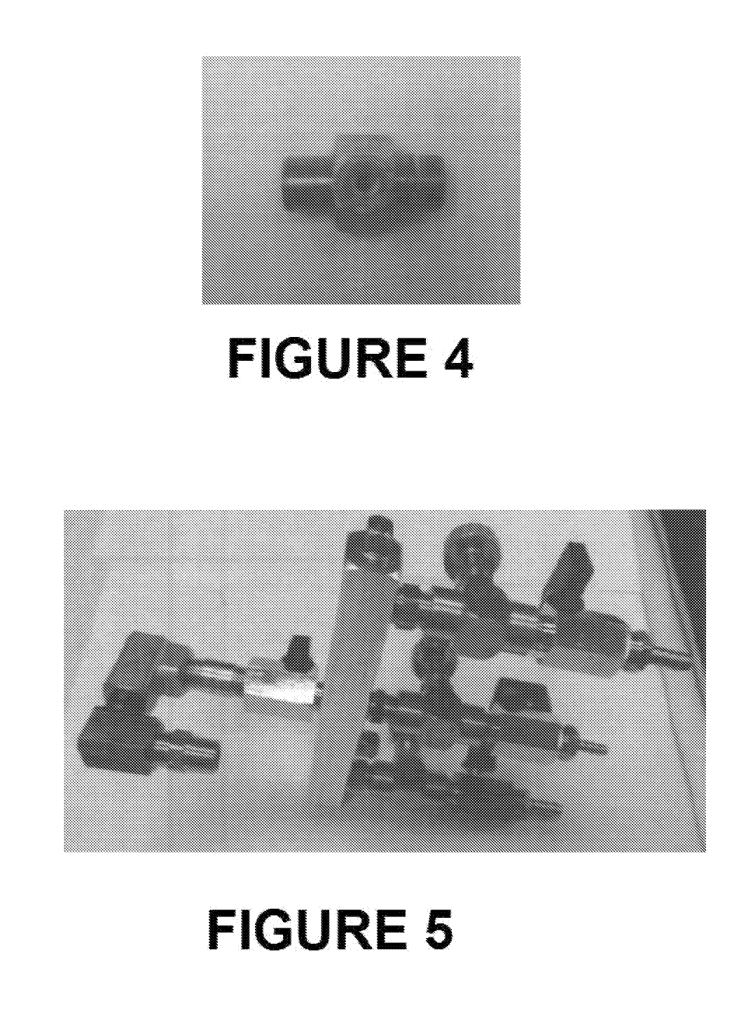

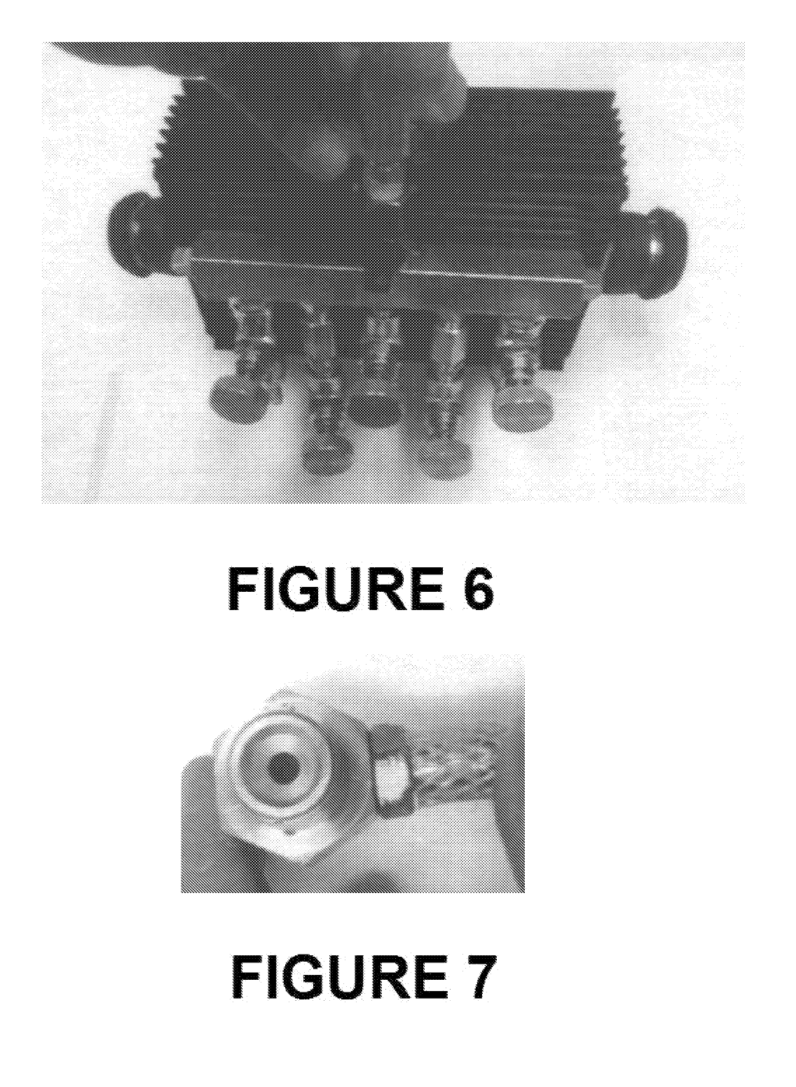

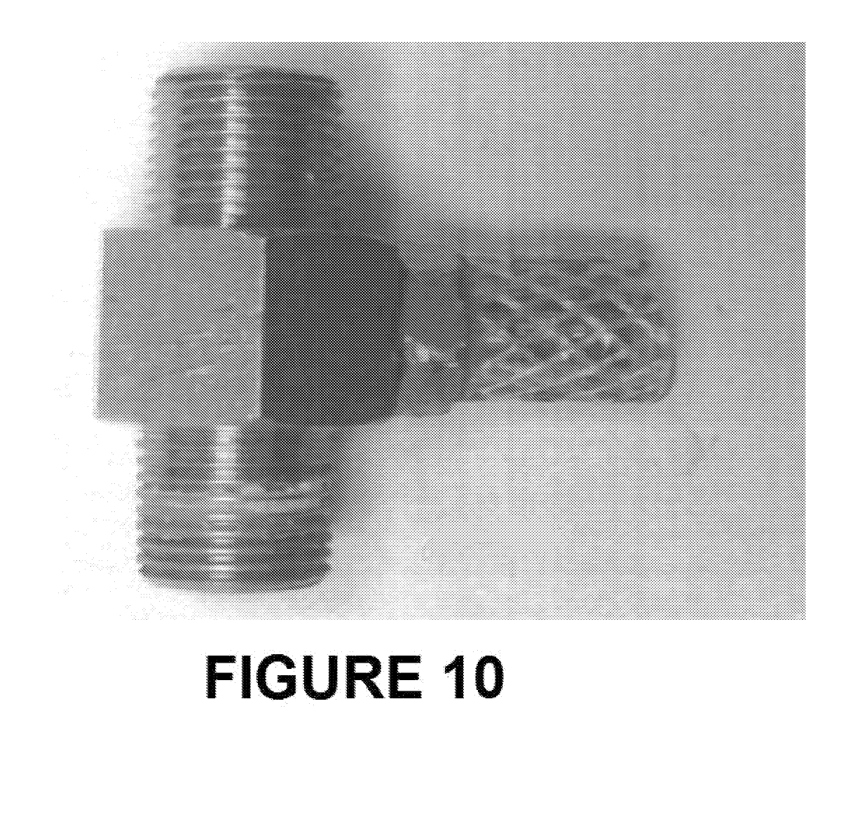

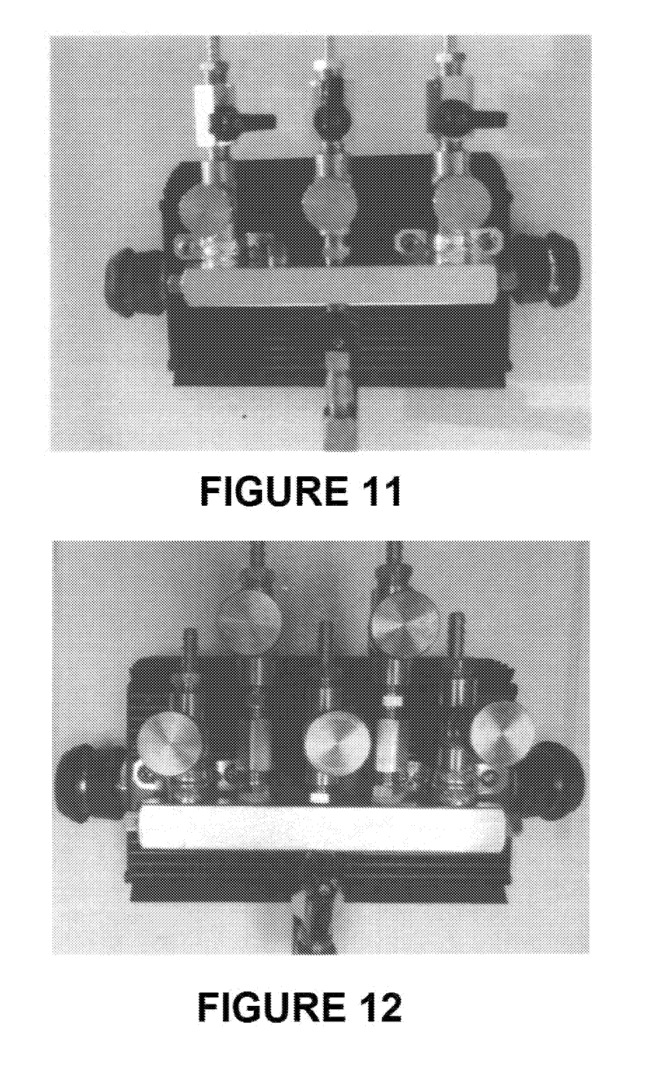

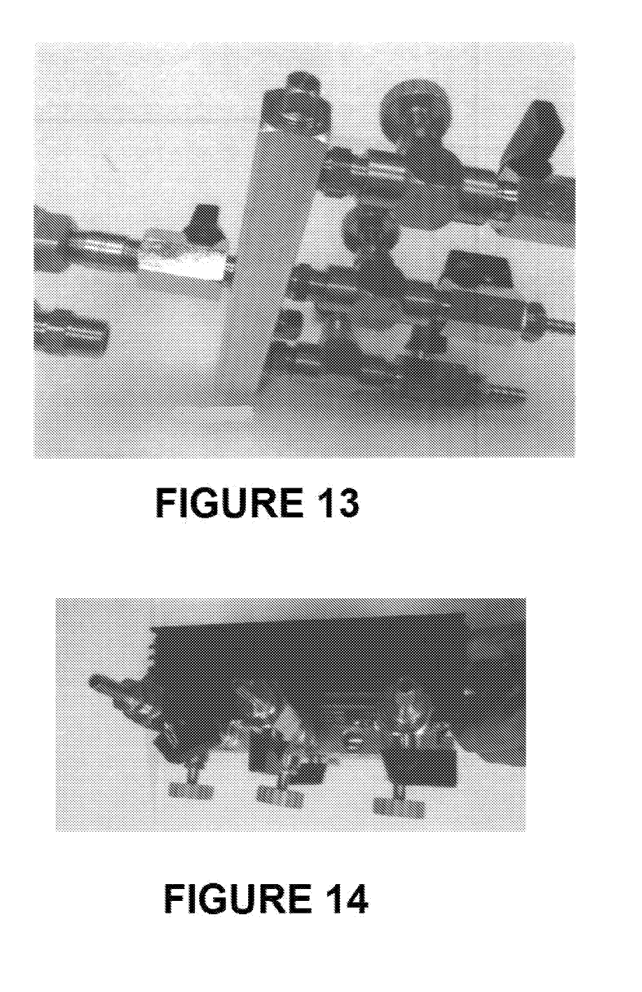

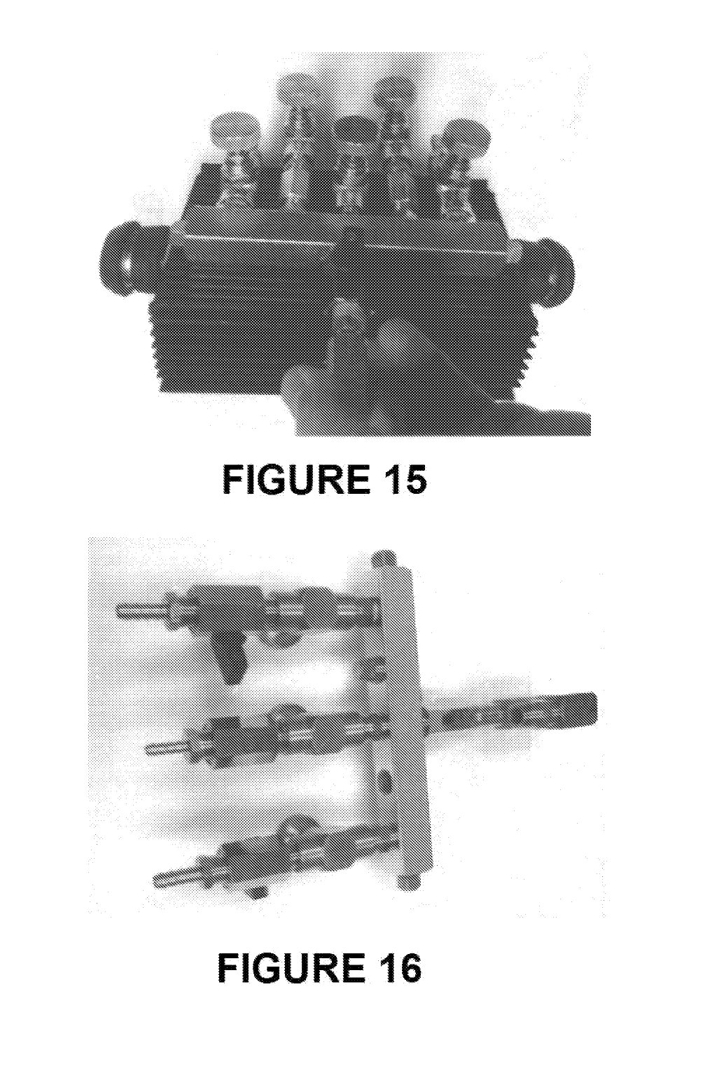

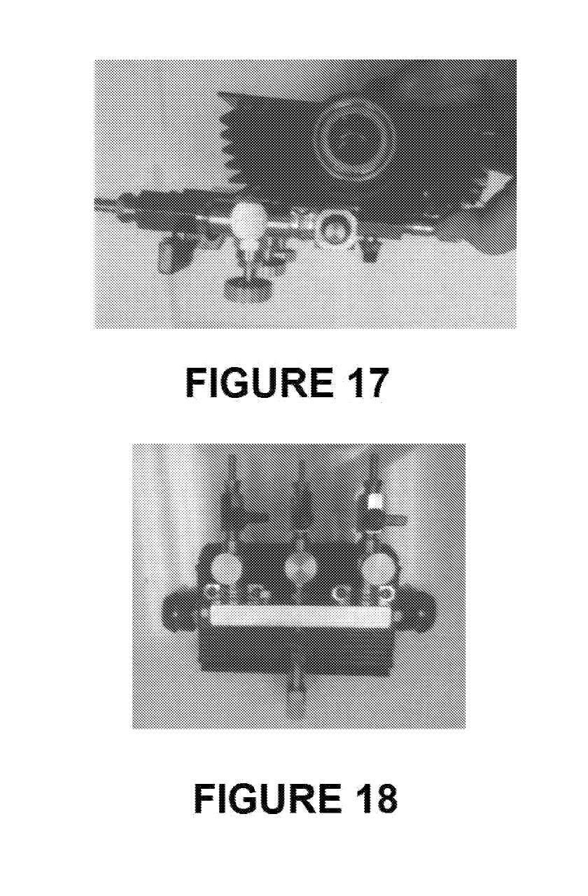

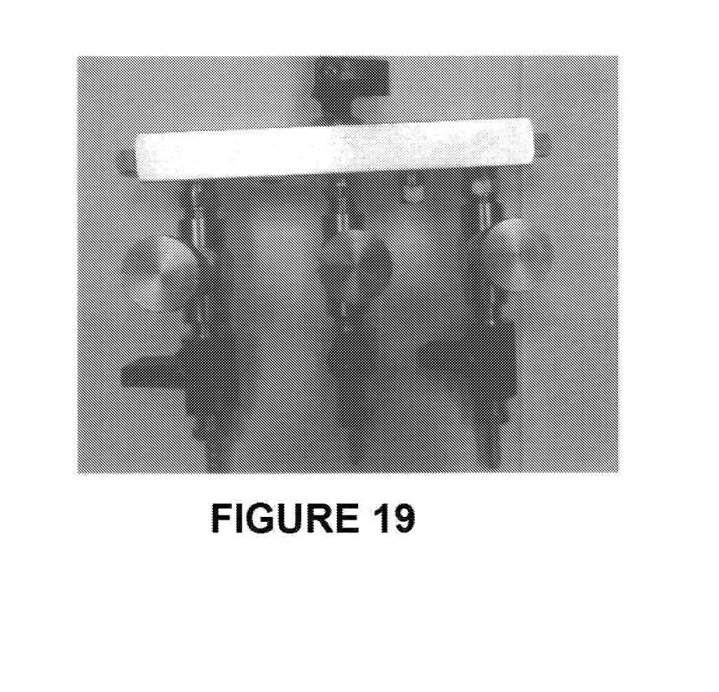

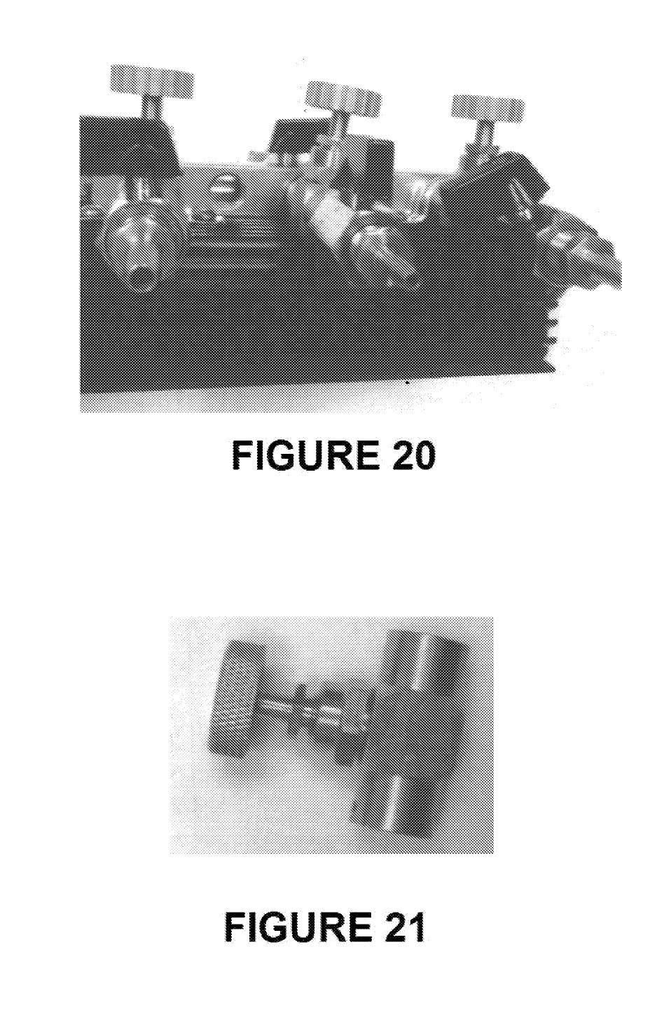

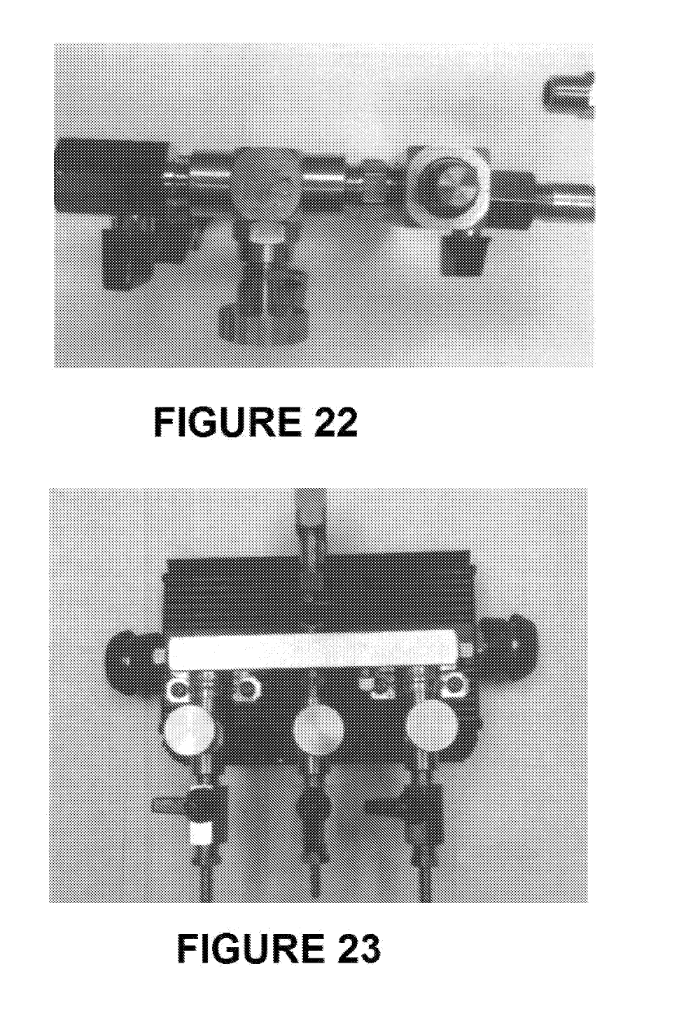

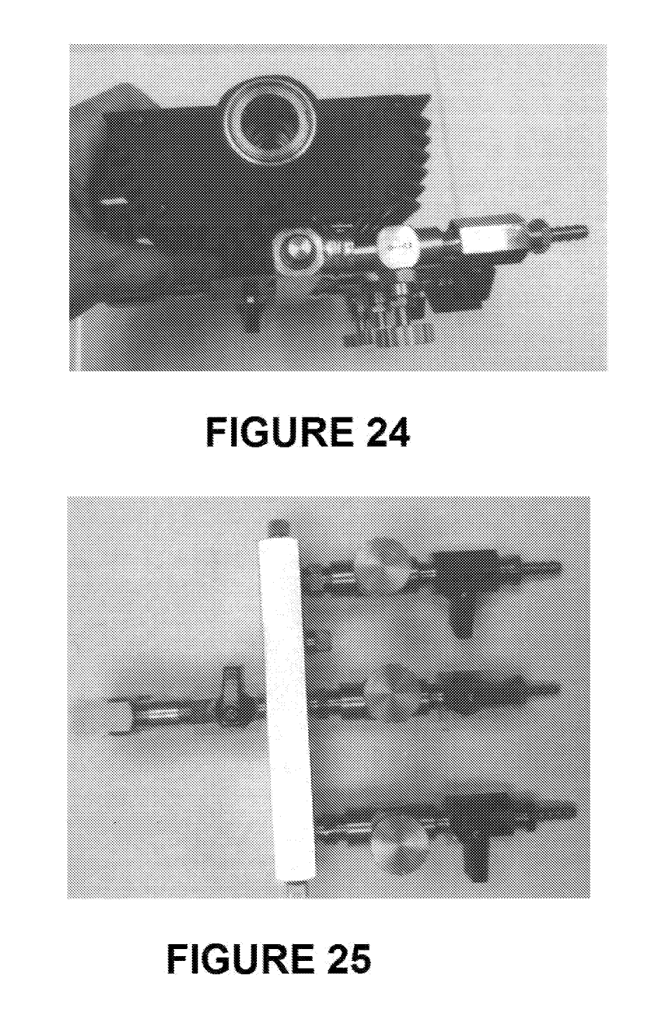

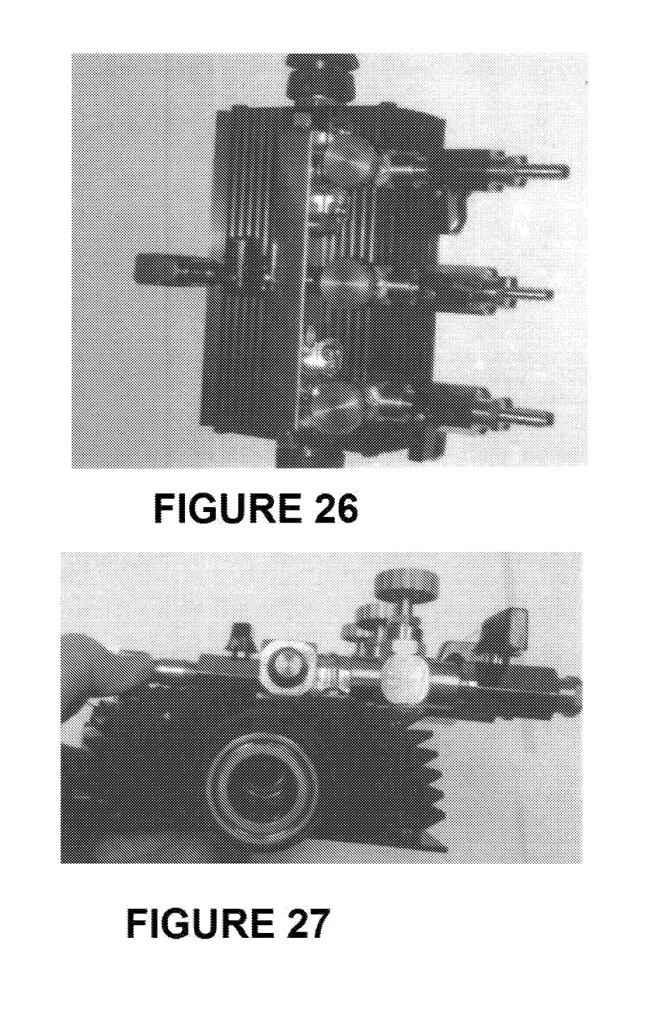

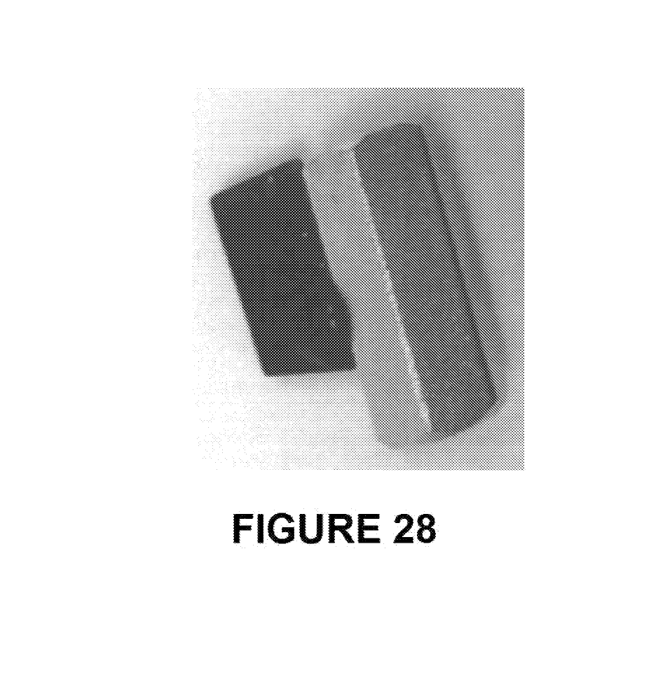

In operation, water enters the supply side of the system through inlet fitting 30 and travels through the water supply line 28 until it reaches the injection valve 26. As best shown in FIGS. 4, 7 and 10, the injection valve 26 is preferably a venturi-type valve that creates a venturi effect, or low pressure down stream suction, as the water passes through the restricted opening therein. The change in pressure within the injection valve 26 creates a suction or negative pressure. This negative pressure or suction is then distributed to the multi-port manifold 12. The suction can then be used in multiple combinations to inject solutions from solution storage containers 22 into the water flow. The mixture of solutions is then carried downstream to the spray nozzle 36 creating a deep foaming spray that can be sprayed directly onto the animal's coat cleaning down to the base of the coat, cleaning all the dirt, oil, loose hair, etc.

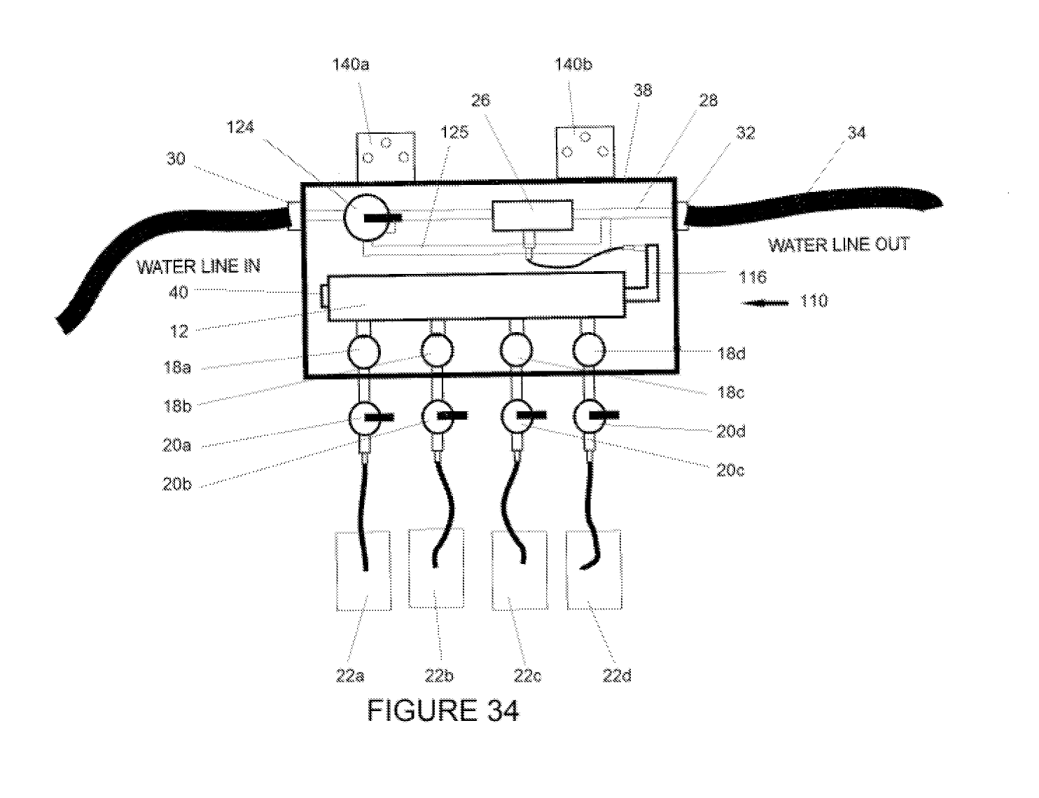

FIG. 34 illustrates a selectable washing system 110 according to an alternative preferred embodiment of the invention. The washing system 110 is similar to the washing system 10 depicted in FIG. 1, wherein like reference numerals indicate like components, and includes a manifold 12 having a plurality of inlet openings 14a, 14b, 14c, 14d and an outlet 116 disposed therein. The primary difference between the washing system 10 depicted in FIG. 1, and the washing system shown in FIG. 34 is that the shut-off valve 24 is replaced by a wash/rinse bypass valve 124 and an accompanying bypass line 125, which causes the water to reroute or bypass the injection valve 26, resulting in a completely clear stream of water for the rinse cycle. In effect, it serves the same purpose of stopping the injection of chemical solution, but does so by completely stopping the flow of water through the injection valve 26. In effect, the wash/rinse bypass valve 124 between the water inlet connection 30 and the injection valve 26 allows the user to go straight from wash mode to rinse mode without waiting for the residual solution to clear the lines.

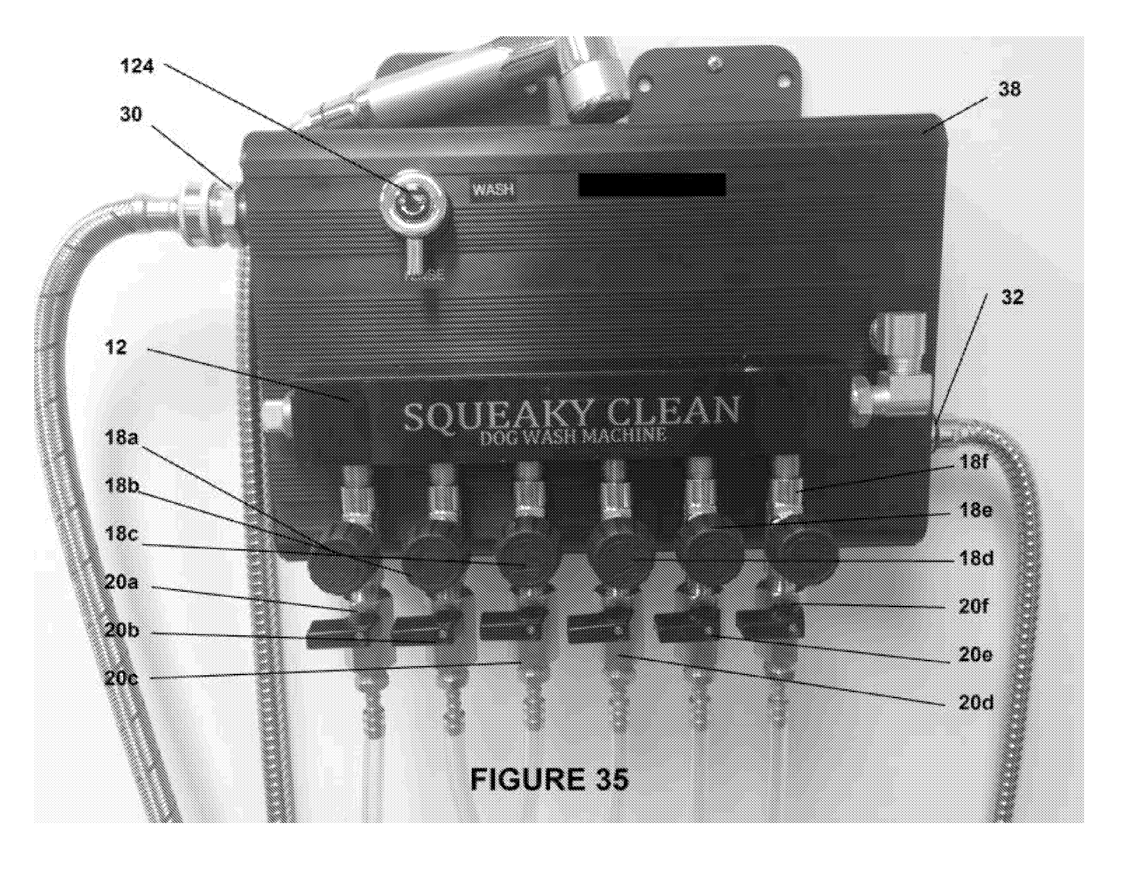

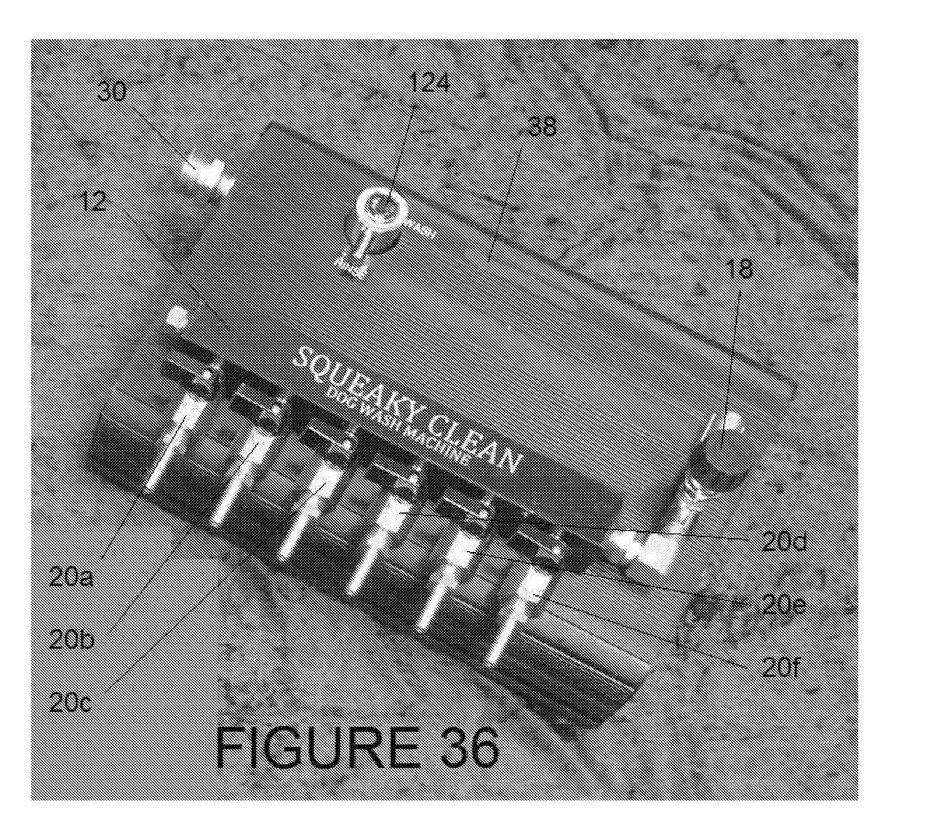

According to the embodiment shown in FIGS. 34 and 35, each of the inlet openings 14a, 14b, 14c, 14d in the manifold 12 is connected to a corresponding solution supply container 22a, 22b, 22c, 22d by a corresponding shut-off valve, such as ball valves 20a, 20b, 20c, 20d, and a corresponding metering valve, such as needle valves 18a, 18b, 18c, 18d. The needle valves 18a, 18b, 18c, 18d allow each source to be set at its own rate of flow or percentage of injection and concentration, and allow an adjustable rate of injection so virtually any shampoo or solution can be used. According to an alternative embodiment, shown in FIG. 36, a single metering valve 18 located at the manifold outlet 116 is used in place of the multiple needle valves shown in FIGS. 34 and 35. In this embodiment the flow rate or injection rate of the chemical solution must be adjusted each time the user switches to a different port or combination of solutions. Brackets 140a, 140b may be provided for mounting of the housing 38 onto a suitable support structure, such as a wall.

The foregoing is provided for purposes of illustrating, explaining, and describing embodiments of the present invention. The specific components and order of the steps listed above, while preferred is not necessarily required. Further modifications and adaptation to these embodiments will be apparent to those skilled in the art and may be made without departing from the scope or spirit of the invention.

I claim:

1. A selectable washing system comprising:
a manifold having a plurality of inlet openings for receiving a plurality of corresponding solutions, said manifold also having an outlet for discharging a mixture of said plurality of solutions;
a plurality of solution supply containers corresponding to and connected to said plurality of inlet openings;
a plurality of inlet valve assemblies corresponding to and positioned between said plurality of solution supply containers and said plurality of inlet openings;
a water supply inlet for introducing a stream of liquid into the selectable washing system;
a system outlet for discharging said stream of liquid from the selectable washing system; and
means for injecting said mixture of said plurality of solutions into said stream of liquid, said injecting means being connected to said manifold outlet, said water supply inlet, and said system outlet.

2. The selectable washing system of claim 1, wherein each of said plurality of inlet valve assemblies includes an adjustable flow valve.

3. The selectable washing system of claim 2, wherein each of said plurality of inlet valve assemblies further includes a shut-off valve.

4. The selectable washing system of claim 3, wherein said adjustable flow valve is a needle valve.

5. The selectable washing system of claim 3, wherein said adjustable flow valve is positioned between said shut-off valve and said manifold inlet opening.

6. The selectable washing system of claim 1, further comprising one or more manifold plugs configured to be removably inserted into a corresponding one or more of said plurality of manifold inlet openings.

7. The selectable washing system of claim 1, wherein said injecting means comprises an injection valve having a liquid inlet port connected to said water supply inlet, a solution inlet port connected to said manifold outlet for receiving said mixture of said plurality of solutions, and an outlet port connected to said system outlet for discharging a combination of said liquid and said mixture of said plurality of solutions.

8. The selectable washing system of claim 7, further comprising a shut-off valve located between said manifold outlet and said solution inlet port of said injection valve.

9. The selectable washing system of claim 7, wherein said injection valve is a venturi valve.

10. The selectable washing system of claim 7, further comprising an inlet fitting connected to said liquid inlet port of said injection valve by a first length of tubing, and an outlet fitting connected to said liquid outlet port of said injection valve by a second length of tubing.

11. The selectable washing system of claim 10, further comprising a length of flexible hose having a first end connected to said outlet fitting and a second end connected to a nozzle.

12. The selectable washing system of claim 1, further comprising bypass means for selectively diverting the stream of liquid around the injecting means.

13. The selectable washing system of claim 12, wherein said injecting means comprises an injection valve having a liquid inlet port connected to said water supply inlet, a solution inlet port connected to said manifold outlet, and an outlet port connected to said system outlet.

14. The selectable washing system of claim 13, wherein the bypass means comprises a valve having an inlet port connected to said water supply inlet, a first outlet port connected to said liquid inlet port of said injection valve, and a second outlet port connected to a first end of a bypass line, wherein a second end of said bypass line is connected between the injection valve outlet port and said system outlet; and means for selectively directing output to one of said first and second outlet ports.
